(19) United States
(12) Patent Application Publication
(10) Pub. No.: US 2010/0160507 A1
(43) Pub. Date: Jun. 24, 2010

(54) Compacted Flame-Retardant Composition

(75) Inventors: Harald BAUER, Kerpen (DE); Sebastian HOEROLD, Diedorf (DE); Werner KRAUSE, Huerth (DE); Martin SICKEN, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT PRODUKTE (DEUTSCHLAND) GMBH, FRANKFURT AM MAIN (DE)

(21) Appl. No.: 12/717,053

(22) Filed: Mar. 3, 2010

Related U.S. Application Data
(62) Division of application No. 11/438,594, filed on May 22, 2006, now abandoned.
Application No. 11/438,594 is a continuation of application No. 10/656,406, filed on Sep. 5, 2003, now abandoned.

(30) Foreign Application Priority Data
Sep. 6, 2002 (DE) 10241376.2

(51) Int. Cl. C09K 21/12; C08K 5/49

(52) U.S. Cl. 524/115; 252/609

(57) ABSTRACT

The invention relates to a compacted flame-retardant composition comprising an organophosphorus flame-retardant component, prepared by compacting an organophosphorus flame-retardant component with or without a compacting auxiliary, and to a process for preparing these flame-retardant compositions, and to polymer molding compositions which comprise these flame-retardant compositions.

The present invention relates to a compacted flame-retardant composition with reduced dusting tendency, and also to a process for preparing this compacted flame-retardant composition, and to the use of the composition.

Organophosphorus compounds are used as flame retardants for plastics such as polyamides or polyesters. In these application sectors, the processing of the organophosphorus flame-retardant component is often made difficult by a tendency toward dusting.

DE 196 50 563 A1 describes pellets comprising thermoplastic polymers, a graft polymer, a thermoplastic copolymer, and a flame retardant comprising iminophosphoranes.

EP 1 081 190 A1 describes flame-retardant thermoplastic molding compositions comprising at least one of the following components: high-molecular-weight syndiotactic polymer based on vinylaromatic monomers and on polyphenylene ether, vinylaromatic amorphous polymer, and flame retardant.

DE 41 39 625 A1 describes pellets composed of polyphenylene ether, vinylaromatic polymer, and an aromatic phosphite.

EP 0 899 296 A2 describes polymer molding compositions comprising a synergistic flame retardant combination for thermoplastic polymers, these being composed of a salt of 1-hydroxydihydrophosphole oxides with another component from the group of benzoguanamine, tris(hydroxyethyl) isocyanurate, allantoin, glycoluril, and also melamine cyanurate, melamine phosphate, dimelamine phosphate, and melamine pyrophosphate, and ammonium polyphosphate.

U.S. Pat. No. 5,021,488 A1 and U.S. Pat. No. 5,102,931 A1 describe thermoplastic flame-retardant non-dripping polyamide compositions whose preparation uses phosphinic esters of polyphenols, anti-dripping agents, polyfluoroethylene polymer, and/or aramid, and zinc borate (hydrates), in a compacted or pulverulent form.

U.S. Pat. No. 5,191,000 A1 describes flame-retardant non-dripping polyalkylene terephthalate compositions whose preparation uses phosphorous esters and anti-dripping agents, in a compacted or pulverulent form.

It was therefore an object to reduce the dusting tendency of flame-retardant compositions. This object is achieved by compacting, preferably roller-compacting, pulverulent flame-retardant compositions. Surprisingly, it has been found that, together with a reduction in dusting, good dispersion of the organophosphorus flame-retardant component in the polymer molding is reliably obtained.

The invention therefore provides a compacted flame-retardant composition comprising an organophosphorus flame-retardant component, prepared by compacting an organophosphorus flame-retardant component with or without a compacting auxiliary.

The organophosphorus flame-retardant component is preferably a phosphinic salt of the formula (I) and/or a diphosphinic salt of the formula (II) and/or polymers of these (component A),

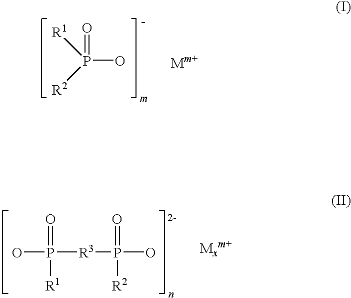

where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Si, Sr, Mn, Li, Na, K, and/or a protonated nitrogen base;
m is from 1 to 4;
n is from 1 to 4;
x is from 1 to 4.
M is preferably calcium, aluminum, or zinc.

Protonated nitrogen bases are preferably the protonated bases of ammonia, melamine, or triethanolamine, in particular NH₄⁺.

Preferred meanings of R¹ and R², identical or different, are C₁-C₆-alkyl, linear or branched, and/or phenyl.

Particularly preferred meanings of R¹ and R², identical or different, are methyl, ethyl, n-propyl, isopropyl, n-butyl, tert-butyl, n-pentyl, and/or phenyl.

Preferred meanings of R³ are methylene, ethylene, n-propylene, isopropylene, n-butylene, tert-butylene, n-pentylene, n-octylene, or n-dodecylene.

Other preferred meanings of R³ are phenylene or naphthylene.

Other preferred meanings of R³ are methylphenylene, ethylphenylene, tert-butylphenylene, methylnaphthylene, ethylnaphthylene, or tert-butylnaphthylene.

Other preferred meanings of R³ are phenylmethylene, phenylethylene, phenylpropylene, or phenylbutylene.

The compacted flame-retardant composition and/or the organophosphorus flame-retardant component also preferably comprise(s) melamine phosphate, dimelamine phosphate, melamine pyrophosphate, melamine polyphosphates, melam polyphosphates, melem polyphosphates, and/or melon polyphosphates.

The compacted flame-retardant composition and/or the organophosphorus flame-retardant component also preferably comprise(s) melamine condensation products, such as melam, melem, and/or melon.

Suitable substances are condensation products of melamine or reaction products of melamine with phosphoric acid, and reaction products of condensation products of melamine with phosphoric acid, and also mixtures of the products mentioned. Examples of condensation products of melamine are melem, melam, or melon, and compounds of this type but with a higher condensation level, and also mixtures of the same. One way of preparing these condensation products uses a process described in WO-A-96/16948.

The reaction products with phosphoric acid are compounds resulting from reaction of melamine or of the condensed melamine compounds, such as melam, melem, or melon, etc., with phosphoric acid. Examples of these are melamine polyphosphate, melam polyphosphate, and melem polyphosphate, and mixed polysalts, e.g. as described in PCT/WO 98139306. The compounds mentioned have been disclosed previously in the literature, and may also be prepared via processes other than the direct reaction with phosphoric acid. For example, melamine polyphosphate may be prepared by a method based on PCT/WO 98/45364, by reacting polyphosphoric acid and melamine, or by a method based on PCT/WO 98/08898 by condensation of melamine phosphate or melamine pyrophosphate.

The compacted flame-retardant composition and/or the organophosphorus flame-retardant component also preferably comprise(s) oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide, and/or guanidine.

The compacted flame-retardant composition and/or the organophosphorus flame-retardant component preferably comprise(s) nitrogen-containing phosphates of the formulae (NH₄)_{y}H_{3-y}PO₄ and, respectively, (NH₄PO₃)_{z}, where y is from 1 to 3 and z is from 1 to 10 000.

The compacted flame-retardant composition and/or the organophosphorus flame-retardant component preferably comprise(s), as component B, a synthetic inorganic compound and/or a mineral product.

Component B is preferably an oxygen compound of silicon, or is magnesium compounds, is metal carbonates of metals of the second main group of the Periodic Table, is red phosphorus, is zinc compounds, or is aluminum compounds.

The oxygen compounds of silicon are particularly preferably salts and esters of orthosilicic acid and condensation products thereof, or are silicates, zeolites, and silicas, are glass powder, glass/ceramic powder, or ceramic powder; the magnesium compounds are magnesium hydroxide, hydrotalcites, magnesium carbonates, or magnesium calcium carbonates; the zinc compounds are zinc oxide, zinc stannate, zinc hydroxystannate, zinc phosphate, zinc borate, or zinc sulfides; the aluminum compounds are aluminum hydroxide or aluminum phosphate.

The compacted flame-retardant composition and/or the organophosphorus flame-retardant component preferably comprise(s) nitrogen compounds as further component C.

The nitrogen compounds are preferably those of the formulae (III) to (VIII) or mixtures thereof

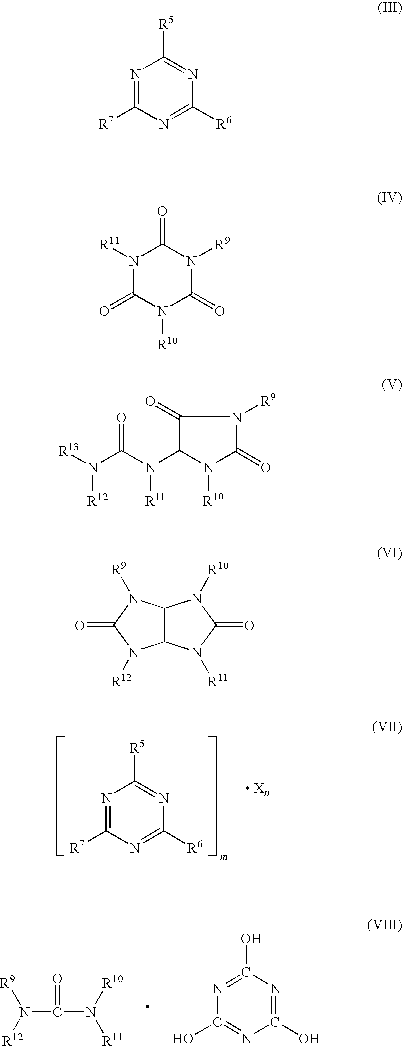

where
R⁵ to R⁷ are hydrogen, C₁-C₈-alkyl, or C₅-C₁₃-cycloalkyl or -alkylcycloalkyl, unsubstituted or substituted with a hydroxy function or with a C₁-C₄-hydroxyalkyl function, or are C₂-C₈-alkenyl, C₁-C₈-alkoxy, acyl, or -acyloxy, or C₆-C₁₂-aryl or -arylalkyl, or —OR⁸ or —N(R⁸)R⁹, or else N-alicyclic systems or N-aromatic systems,
R⁸ is hydrogen, C₁-C₈-alkyl, C₅-C₁₈-cycloalkyl or -alkylcycloalkyl, unsubstituted or substituted with a hydroxy function or with a C₁-C₄-hydroxyalkyl function, or is C₂-C₈-alkenyl, C₁-C₈-alkoxy, -acyl, or acyloxy, or C₈-C₁₂-aryl or -arylalkyl,
R⁹ to R¹³ are the groups of R⁸, or else —O—R⁸,
m and n, independently of one another, are 1, 2, 3, or 4,
X is acids which can form adducts with triazine compounds (III).

The compacted flame-retardant composition and/or the organophosphorus flame-retardant component preferably also comprise(s) carbodiimides.

The compacted flame-retardant composition of the invention preferably has a median particle size of from 100 to 2000 μm, preferably from 200 to 1000 μm.

The compacted flame-retardant composition of the invention preferably has an average bulk density of from 200 to 1500 g/l, preferably from 300 to 1000 g/l.

The quantitative ratio of amount of compacting auxiliary to organophosphorus flame-retardant component is from 1:199 to 1:0.11, preferably from 1:99 to 1:0.25, and particularly preferably from 1:49 to 1:1.

The median particle size of the organophosphorus component used is from 0.1 to 1000 μm, preferably from 1 to 100 μm.

The preferred bulk density of the organophosphorus component used is from 80 to 800 g/l, preferably from 200 to 700 g/l.

The invention also includes synergistic combinations of the phosphinates mentioned with certain nitrogen-containing compounds, these being more effective as flame retardants than the phosphinates alone in very many polymers (DE 19614 424 A1, DE 197 34 437 A1, and DE 197 37 727 A1).

Additives: The flame-retardant action of the surface-modified phosphinates can be improved by combination with other flame retardants, preferably with nitrogen-containing synergists, or with phosphorus/nitrogen flame retardants.

The invention also provides a process for producing compacted flame-retardant compositions, which comprises compacting the organophosphorus flame-retardant component with or without a compacting auxiliary under pressures of from 1 to 60 kN/cm².

This process is preferably roller compaction.

The contact area of the rollers, and therefore the effective pressure, is not particularly well defined in the roller compaction process, and the linear pressure is therefore given. This is the force acting per cm length of the compacting rollers.

A linear pressure of from 1 to 30 kN/cm is preferably used during the roller compaction process.

A linear pressure of from 2 to 20 kN/cm is particularly preferably used during the roller compaction process.

A preferred compacting auxiliary is alkylalkoxylates having from 8 to 22 carbon atoms and from 1 to 80 EO units per mole of alcohol.

A preferred compacting auxiliary is caprolactam and/or triphenyl phosphate.

A preferred compacting auxiliary is ethylene glycol, propylene glycol, and/or butylene glycol, their oligomers and/or polymers, and/or their ethers.

A preferred compacting auxiliary is naturally occurring, chemically modified, and/or synthetic waxes; preferably carnauba waxes and montan waxes.

A preferred compacting auxiliary is synthetic resins, preferably phenolic resins.

Preferred compacting auxiliaries are esters, amides, anhydrides, hydrates, and salts of saturated aliphatic mono-, di-, tri-, and polycarboxylic acids.

Other preferred compacting auxiliaries are C₁-C₂₀-(alkyl, oxalkyl, alkenyl, alkynyl, aralkyl, alkylaryl, or aryl) monocarboxylates, C₁-C₂₀-(alkyl, oxalkyl, alkenyl, alkynyl, aralkyl, alkylaryl, or aryl) dicarboxylates, C₁-C₂₀-(alkyl, oxalkyl, alkenyl, alkynyl, aralkyl, alkylaryl, or aryl) tricarboxylates, C₁-C₂₀-(alkyl, oxalkyl, alkenyl, alkynyl, aralkyl, alkylaryl, or aryl) oligocarboxylates, C₁-C₂₀-(alkyl, oxalkyl, alkenyl, alkynyl, aralkyl, alkylaryl or aryl) polycarboxylates.

Other preferred compacting auxiliaries are monoorganyl or diorganyl esters of a dicarboxylic acid; monoorganyl or diorganyl, or triorganyl esters of a tricarboxylic acid; monoorganyl, diorganyl, triorganyl, or oligoorganyl esters of an oligocarboxylic acid; monoorganyl, diorganyl, triorganyl, oligoorganyl, or polyorganyl esters of a polycarboxylic acid, or a mixture of these.

Other preferred compacting auxiliaries are esters of phthalic acid, among which are monoorganyl esters of phthalic acid and bisorganyl esters of phthalic acid (examples of organyl being alkyl, oxalkyl, alkenyl, alkynyl, aralkyl, alkylaryl or aryl), preference being given to monoalkyl esters of phthalic acid and dialkyl esters of phthalic acid (alkyl=linear, branched, cyclic, substituted cyclic, or heterocyclic C₁-C₂₀), e.g. dimethyl phthalate, diethyl phthalate, dipropyl phthalate, diisopropyl phthalate, dibutyl phthalate, epoxidized di(2-ethylhexyl) phthalate, diisooctyl phthalate, dioctyl phthalate, diisononyl phthalate, n-octyl phthalate, n-decyl phthalate, diisodecyl phthalate, butyl benzyl phthalate, butyl cyclohexyl phthalate, dicapryl phthalate, di(3,5,5-trimethylhexyl) phthalate, di(1-allyl-2,2,6,6-tetramethylpiperidin-4-yl) phthalate.

Other preferred compacting auxiliaries are esters of isophthalic acid, among which are monoorganyl esters of isophthalic acid and bisorganyl esters of isophthalic acid (examples of organyl being alkyl, oxalkyl, alkenyl, alkynyl, aralkyl, alkylaryl, or aryl), preference being given to monoalkyl esters of isophthalic acid and dialkyl esters of isophthalic acid (alkyl=linear, branched, cyclic, substituted cyclic, or heterocyclic C₁-C₂₀), e.g. di(2-ethylhexyl) isophthalate.

Other preferred compacting auxiliaries are esters of terephthalic acid, among which are monoorganyl esters of terephthalic acid and bisorganyl esters of terephthalic acid (examples of organyl being alkyl, oxalkyl, alkenyl, alkynyl, aralkyl, alkylaryl, or aryl), preference being given to monoalkyl esters of terephthalic acid and dialkyl esters of terephthalic acid (alkyl=linear, branched, cyclic, substituted cyclic, or heterocyclic C₁-C₂₀).

Other preferred compacting auxiliaries are esters of oxalic acid, esters of malonic acid (e.g. di(2,2,6,6-tetramethylpiperidin-4-yl) diethylmalonate, di(1,2,2,6,6-pentamethylpiperidin-4-yl) dibutylmalonate, di(1,2,2,6,6-pentamethylpiperidin-4-yl) butyl(3,5-di-tert-butyl-4-hydroxybenzyl)malonate), esters of succinic acid (e.g. di(2,2,6,6-tetramethylpiperidin-4-yl) succinate), and esters of glutaric acid (e.g. di(2,2,6,6-tetramethylpiperidin-4-yl) glutarate).

Other preferred compacting auxiliaries are esters of adipic acid, among which are monoorganyl esters of adipic acid and bisorganyl esters of adipic acid (examples of organyl being alkyl, oxalkyl, alkenyl, alkynyl, aralkyl, alkylaryl, or aryl, preference being given to monoalkyl esters of adipic acid and dialkyl esters of adipic acid (alkyl=linear, branched, cyclic, substituted cyclic, or heterocyclic C₁-C₂₀), e.g. dimethyl adipate, diethyl adipate, di-n-propyl adipate, diisopropyl adipate, di-n-butyl adipate, diisobutyl adipate, di-tert-butyl adipate, di(n-octyl) adipate, di(2-ethylhexyl) adipate, diisodecyl adipate, n-octyl adipate, 2-ethylhexyl adipate, n-decyl adipate, isodecyl adipate, di(2,2,6,6-tetramethylpiperidin-4-yl) adipate.

Other preferred compacting auxiliaries are esters of pimelic acid, suberic acid, esters of azelaic acid (e.g. dialkyl azelate, particularly di(2-ethylhexyl) azelate, and esters of 1,13-tridecanedicarboxylic acid (brassylic acid).

Other preferred compacting auxiliaries are esters of sebacic acid, among which are monoorganyl esters of sebacic acid and diorganyl esters of sebacic acid (examples of organyl being alkyl, oxalkyl, alkenyl, alkynyl, aralkyl, alkylaryl, or aryl, preference being given to monoalkyl esters of sebacic acid and dialkyl esters of sebacic acid (alkyl=linear, branched, cyclic, substituted cyclic, or heterocyclic C₁-C₂₀), e.g. dialkyl sebacate, particularly di(2-ethylhexyl) sebacate, di(2,2,6,6-tetramethylpiperidin-4-yl) sebacate, di(1,2,2,6,6-pentamethylpiperidin-4-yl) sebacate, di(1,2,3,6-tetramethyl-2,6-diethyl-piperidin-4-yl) sebacate, di(1-octyloxy-2,2,6,6-tetramethylpiperidin-4-yl) sebacate, di(1-cyclohexyloxy-2,2,6,6-tetramethylpiperidin-4-yl) sebacate.

Other preferred compacting auxiliaries are esters of tetrahydrophthalic acid, among which are monoorganyl esters of tetrahydrophthalic acid and bisorganyl esters of tetrahydrophthalic acid (examples of organyl being alkyl, oxalkyl, alkenyl, alkynyl, alkylaryl, or aryl), preference being given to monoalkyl esters of tetrahydrophthalic acid and dialkyl esters of tetrahydrophthalic acid (alkyl=linear, branched, cyclic, substituted cyclic, or heterocyclic C₁-C₂₀), e.g. di(2-ethylhexyl) tetrahydrophthalate.

Other preferred compacting auxiliaries are esters of tetrahydroisophthalic acid, among which are monoorganyl esters of tetrahydrophthalic acid and bisorganyl esters of tetrahydroisophthalic acid (examples of organyl being alkyl, oxalkyl, alkenyl, alkynyl, alkylaryl, or aryl), preference being given to monoalkyl esters of tetrahydroisophthalic acid and dialkyl esters of tetrahydroisophthalic acid (alkyl=linear, branched, cyclic, substituted cyclic, or heterocyclic C₁-C₂₀).

Other preferred compacting auxiliaries are esters of tetrahydroterephthalic acid, among which are monoorganyl esters of tetrahydroterephthalic acid and bisorganyl esters of tetrahydroterephthalic acid (examples of organyl being alkyl, oxalkyl, alkenyl, alkynyl, alkylaryl, or aryl), preference being given to monoalkyl esters of tetrahydroterephthalic acid and dialkyl esters of tetrahydroterephthalic acid (alkyl=linear, branched, cyclic, substituted cyclic, or heterocyclic C₁-C₂₀).

Other preferred compacting auxiliaries are esters of hexahydrophthalic acid, among which are monoorganyl esters of hexahydrophthalic acid and bisorganyl esters of hexahydrophthalic acid (examples of organyl being alkyl, oxalkyl, alkenyl, alkynyl, alkylaryl, or aryl), preference being given to monoalkyl esters of hexahydrophthalic acid and dialkyl esters of hexahydrophthalic acid (alkyl=linear, branched, cyclic, substituted cyclic, or heterocyclic C₁-C₂₀), e.g. di(2-ethylhexyl) hexahydrophthalate.

Other preferred compacting auxiliaries are esters of hexahydroisophthalic acid, among which are monoorganyl esters of hexahydroisophthalic acid and bisorganyl esters of hexahydroisophthalic acid (examples of organyl being alkyl, oxalkyl, alkenyl, alkynyl, alkylaryl, or aryl), preference being given to monoalkyl esters of hexahydroisophthalic acid and dialkyl esters of hexahydroisophthalic acid (alkyl=linear, branched, cyclic, substituted cyclic, or heterocyclic C₁-C₂₀).

Other preferred compacting auxiliaries are esters of hexahydroterephthalic acid, among which are monoorganyl esters of hexahydroterephthalic acid and bisorganyl esters of hexahydroterephthalic acid (examples of organyl being alkyl, oxalkyl, alkenyl, alkynyl, alkylaryl, or aryl), preference being given to monoalkyl esters of hexahydroterephthalic acid and dialkyl esters of hexahydroterephthalic acid (alkyl=linear, branched, cyclic, substituted cyclic, or heterocyclic C₁-C₂₀).

Other preferred compacting auxiliaries are esters of maleic acid, among which are monoorganyl esters of maleic acid and bisorganyl esters of maleic acid (examples of organyl being alkyl, oxalkyl, alkenyl, alkynyl, alkylaryl, or aryl), preference being given to monoalkyl esters of maleic acid and dialkyl esters of maleic acid (alkyl=linear, branched, cyclic, substituted cyclic, or heterocyclic C₁-C₂₀), e.g. di(1-benzyl-2,2,6,6-tetramethylpiperidin-4-yl) maleate.

Other preferred compacting auxiliaries are esters of hydroxycarboxylic acids, hydroxydicarboxylic acids, hydroxytricarboxylic acids, hydroxyoligocarboxylic acids, and/or hydroxypolycarboxylic acids, e.g. tartronic acid, malic acid, tartaric acid, citric acid, etc.

Other preferred compacting auxiliaries are esters of citric acid, among which are monoorganyl esters of citric acid and bisorganyl esters of citric acid (examples of organyl being alkyl, oxalkyl, alkenyl, alkynyl, alkylaryl, or aryl), preference being given to monoalkyl esters of citric acid and dialkyl esters of citric acid (alkyl=linear, branched, cyclic, substituted cyclic, or heterocyclic C₁-C₂₀).

Other preferred compacting auxiliaries are butyl epoxystearate, hexyl epoxystearate, epoxidized soy oil, epoxidized octyl tallate, epoxidized octyl oleate, tetraethylene glycol di(2-ethylhexoate), and triethyleneglycol di(2-ethylhexoate).

Other preferred compacting auxiliaries are esters of mono-, di-, tri-, tetra-, or pentahydric alcohols, and those of higher polyols.

Other preferred compacting auxiliaries are mono-, di-, tri-, or tetraorganyl esters of pentaerythritol, and mixtures of these, e.g. pentaerythritol tetrabenzoate.

Other preferred compacting auxiliaries are sulfonamide-based compounds, particularly preferably aromatic sulfonamides, e.g. N-ethyltoluenesulfonamide,

N-cyclohexyltoluenesulfonamide, N-butylbenzenesulfonamide, N-methylbenzenesulfonamide, N-butylbenzenesulfonamide, p-toluenesulfonamide, N-ethyl-p-toluenesulfonamide, and N-cyclohexyl-p-toluenesulfonamide.

Other preferred compacting auxiliaries are glycerol, hexyl glycol, and modified urethane prepolymer which has a weight-average molecular weight of from 400 to 2000, preferably from 600 to 1000.

Other preferred compacting auxiliaries are esters of p-hydroxybenzoic acid, e.g. hexyloxyethoxyethyl p-hydroxybenzoate, hexyloxypropoxypropyl p-hydroxybenzoate, hexyloxybutoxybutyl p-hydroxybenzoate, octyioxyethoxyethyl p-hydroxybenzoate, octyloxypropoxypropyl p-hydroxybenzoate, octyloxybutoxybutyl p-hydroxybenzoate, 2′-ethylhexyloxyethoxyethyl p-hydroxybenzoate, 2′-ethylhexyloxypropoxypropyl

p-hydroxybenzoate, 2′-ethylhexyloxybutoxybutyl p-hydroxybenzoate, decyloxyethoxyethyl p-hydroxybenzoate, decyloxypropoxypropyl p-hydroxybenzoate, decyloxybutoxybutyl p-hydroxybenzoate.

Other preferred compacting auxiliaries are alkyl esters of p-hydroxybenzoic acid, e.g. octyl p-hydroxybenzoate, 2-ethylhexyl p-hydroxybenzoate, heptyl p-hydroxybenzoate, 2-ethyldecyl p-hydroxybenzoate, 2-octyloctyl p-hydroxybenzoate, and 2-decyldodecyl p-hydroxybenzoate.

Other preferred compacting auxiliaries are phenols, such as beta-naphthol, dibenzylphenol, and octylcresol.

Phosphorus compounds of oxidation state +5 which may be used are especially alkyl- and aryl-substituted phosphates. Examples are phenyl bisdodecyl phosphate, phenyl ethyl hydrogenphosphate, phenyl bis(3,5,5-trimethylhexyl) phosphate, ethyl diphenyl phosphate, 2-ethylhexyl di(tolyl) phosphate, diphenyl hydrogenphosphate, bis(2-ethylhexyl) p-tolyl phosphate, tritolyl phosphate, bis(2-ethylhexyl)phenyl phosphate, di(nonyl)phenyl phosphate, phenyl methyl hydrogenphosphate, di(dodecyl) p-tolyl phosphate, p-tolyl bis(2,5,5-trimethylhexyl) phosphate, or

2-ethylhexyl diphenyl phosphate. Triphenyl phosphate, and resorcinol bis(diphenyl phosphate) (RDP) and its ring-substituted derivatives are very particularly suitable.

Other preferred compacting auxiliaries are tri(butoxyethyl) phosphate, trioctyl phosphate, tricresyl phosphate, 2-ethylhexyl diphenyl phosphate, cresyl diphenyl phosphate.

Other preferred compacting auxiliaries are organic salts of polyvalent metals, particularly preferably organic salts of elements of the second, third, or fourth main group, or of the second transition group, particularly of the elements magnesium, calcium, strontium, barium, zinc, cadmium, aluminum, tin, lead. Particular preference is given to carboxylic acids having at least 12 carbon atoms, dodecanoic acid (lauric acid), coconut acid, tetradecanoic acid (myristic acid), hexadecanoic acid (palmitic acid, cetylic acid), octadecanoic acid (stearic acid), cis-9-octadecenoic acid (oleic acid), trans-9-octadecenoic acid (elaidic acid), eicosanoic acid (arachidic acid), docosanoic acid (behenic acid).

The invention also provides a flame-retardant polymer molding composition which comprises the compacted flame-retardant composition of the invention.

The flame-retardant polymer molding composition preferably comprises

from 1 to 50% by weight of compacted flame-retardant composition,
from 1 to 99% by weight of thermoplastic polymer or a mixture of the same
from 0 to 60% by weight of additives
from 0 to 60% by weight of filler.

The flame-retardant polymer molding composition particularly preferably comprises

from 5 to 30% by weight of compacted flame-retardant composition,
from 5 to 90% by weight of the thermoplastic polymer or a mixture of the same
from 5 to 40% by weight of additives
from 5 to 40% by weight of filler.

The flame-retardant polymer molding composition preferably also comprises component B and/or C, as described above.

The thermoplastic polymers are preferably HI (high-impact) polystyrene, polyphenylene ethers, polyamides, polyesters, polycarbonates, or blends or polyblends of the type represented by ABS (acrylonitrile-butadiene-styrene), or PC/ABS (polycarbonate/acrylonitrile-butadiene-styrene).

The thermoplastic polymers are particularly preferably polyamide, polyester, or ABS.

Finally, the invention also provides polymer moldings, polymer films, polymer filaments, or polymer fibers, comprising the compacted flame-retardant composition of the invention.

The polymer of the polymer moldings, polymer films, polymer filaments, or polymer fibers is a thermoplastic or thermoset polymer.

The thermoplastic polymers are preferably HI (high-impact) polystyrene, polyphenylene ethers, polyamides, polyesters, polycarbonates, or blends or polyblends of the type represented by ABS (acrylonitrile-butadiene-styrene), or PC/ABS (polycarbonate/acrylonitrile-butadiene-styrene), polyamide, polyester, and/or ABS.

Preferred thermoplastic polymers are polyethylene (PE), polypropylene (PP), polystyrene (PS), polyvinyl chloride (PVC), polyacrylonitrile (PAN), and polyacrylates.

The thermoset polymers are preferably formaldehyde polymers, epoxy polymers, melamine polymers, or phenolic resin polymers, and/or polyurethanes.

The polymer moldings, polymer films, polymer filaments, or polymer fibers preferably comprise

from 1 to 50% by weight of compacted flame-retardant composition,
from 1 to 99% by weight of thermoplastic polymer or a mixture of the same
from 0 to 60% by weight of additives
from 0 to 60% by weight of filler.

The polymer moldings, polymer films, polymer filaments, or polymer fibers particularly preferably comprise

from 5 to 30% by weight of compacted flame-retardant composition,
from 5 to 90% by weight of the thermoplastic polymer or a mixture of the same
from 5 to 40% by weight of additives
from 5 to 40% by weight of filler.

Preferred thermoplastic polymers are polyethylene (PE), polypropylene (PP), polystyrene (PS), polyvinyl chloride (PVC), polyacrylonitrile (PAN), polyamide (PA), polyester (PES), polycarbonate and polyacrylates.

Preferred thermoplastic polymers are formaldehyde polymers, epoxy polymers, melamine polymers, or phenolic resin polymers, and polyurethanes.

Flame-retardant coating comprising at least

from 1 to 50% of compacted flame-retardant composition
from 0 to 60% of ammonium polyphosphate

### Description of Compacting Auxiliaries

Waxes are naturally occurring or synthesized substances which at 20° C. are solid and kneadable, and above 40° C. undergo melting without decomposition and have low viscosity. The temperature at which waxes generally convert into the molten, low-viscosity state is from 50 to 90° C., or in exceptional cases up to about 200° C. A distinction is made between naturally occurring waxes, such as carnauba wax, chemically modified waxes, such as montan ester waxes, and synthetic waxes, such as polyethylene waxes.

Montan waxes for polymer processing are internal and external lubricants for the processing of polyvinyl chloride, polyolefins, polyamide, polystyrene, linear polyesters, thermoplastic polyurethane, curable molding compositions, and other polymers. They are downstream products from the refining of crude montan wax, which is obtained by extracting brown coal. They are long-chain carboxylic acids having chain lengths of from C28 to C32, or are their full or partial esters with ethylene glycol, glycerol, or butylene glycol, or are alkaline earth metal salts of partially hydrolyzed esters, e.g. ®Licowax E, ®Licowax WE 4, and ®Licowax OP.

Polyethylene waxes are suitable for the polymer sector (PVC, rubber, polyolefins). Examples are ®Licowax PE 520, ®Licowax PE 810, ®Licowax PE 820, ®Licowax PE 830, ®Licowax PE 840, ®Licomont CaV, ®Licolub WE4, Ceridust 5551.

Preferred alkylalkoxylates used are ethoxylated alcohols, preferably primary alcohols, preferably having from 8 to 22 carbon atoms, and preferably having from 1 to 80 EO units per mole of alcohol, the alcohol radical being linear or preferably methyl-branched at the 2-position, or comprising a mixture of linear and methyl-branched radicals, as is usually the case in oxo alcohol radicals. Examples of preferred ethoxylated alcohols are C11 alcohols having 3, 5, 7, 8, or 11 EO units, (C₁₂-C₁₆) alcohols having 3, 6, 7, 8, 10, or 13 EO units, (C₁₄-C₁₅) alcohols having 4, 7, or 8 EO units, (C₁₆-C₁₈) alcohols having 8, 11, 15, 20, 25, 50, or 80 EO units, and mixtures of the same, e.g. the ®Genapol grades T80, T110, T150, T200, T250, T500, T800 from Clariant GmbH. The degrees of ethoxylation given are statistical averages which for a specific product may be an integer or a non-integer. In addition to these, use may also be made of fatty alcohol-EO/PO adducts.

Preference is also given to polyethylene glycols H(OCH₂CH₂O)ₙOH with molecular weights of from 500 to 40 000. Particularly preferred grades are ®PEG 600, 800, 1000, 1500, 2000, 3000, 4000, 6000, 8000, 10000, 12000, 20000, 35000.

Preference is also given to monoalkyl ethers of polyethylene glycol, monoallyl ethers of polyethylene glycol, and monovinyl ethers of polyethylene glycol.

Preference is also given to caprolactam and triphenyl phosphate.

Preference is also given to synthetic resins, which according to DIN 55958 are synthetic resins prepared by a polymerization, polyaddition, or polycondensation reaction. Thermosets is a collective term for any of the plastics prepared from curable resins. Among the thermosets are epoxy resins, polyurethanes, phenolic resins, melamine resins, and also unsaturated polyester resins. An example of a preferred phenolic resin is the grade 28391 from Durez.

### Process

The preferred process for preparing the compacted flame-retardant composition of the invention is compaction. In this process, the solid particles are forced into contact with each other by exposure to external pressure. The solid body formed is mechanically comminuted by breaking to give particles, and these are classified. The classified product (correct-grain-size product) is the compacted flame-retardant composition (CFC) of the invention.

Methods used for pressure granulation are roller compaction, briquetting, etc.

In roller compaction, the pulverulent starting material is fed between two rollers which draw the material in and compact it. The primary compactate is a sheet or, if the rollers have a structure, cigar-shaped crusts. The crusts are comminuted mechanically. In roller compaction, a preferred linear pressure is from 1 to 30 kN/cm, and a particularly preferred linear pressure is from 2 to 20 kN/cm.

Preferred apparatus for the roller compaction process are compactors from the companies Hosokawa-Bepex GmbH (Pharmapaktor R) and Alexanderwerk (WP 120×40 V, WP 170×120 V, WP 200×75 VN, WP 300×100 V), and roll presses from the company Köppern.

The particle size is optimized by grinding followed by classification. Examples of suitable equipment for the grinding process are hammer mills, impact mills, vibration grinding mills, ball mills, roll mills, and floating-roll mills from the company Neuman & Esser, and also air-jet mills, such as machines from the company Hosokawa-Alpine. Classification processes used are sifting and/or sieving. For the sieving process use may be made of Allgeier, Rhewum, or Locker sieves, for example.

If desired, grinding auxiliaries may be added.

When compared with a melt agglomerate, this pressed granular material has the advantage that the amount of compacting auxiliaries needed is smaller or zero.

Surprisingly, it has been found that the compacted flame-retardant compositions of the invention exhibit very good dispersion behavior in the polymer.

Good particle dispersion is vital if the surface finish and surface quality are to be good and esthetically pleasing, and is vital for good mechanical strength properties.

In one embodiment, the compacted flame-retardant composition of the invention may be prepared by adding the compacting auxiliary in solid or liquid form to the organophosphorus component kept in motion in a suitable mixer, and mixing for from 0.01 to 1 hour at from 50 to 300° C.

Suitable mixers may be: plowshare mixers from the company Lödige, rotating-disc mixers from the company Lödige, (e.g. CB30), Flexomix mixers from the company Schugi, HEC rotating-disc mixers from the company Niro, rotating-disc mixers (e.g. K-TTE4) from the company Drais, Mannheim, Germany, Eirich mixers (e.g. R02), Telschig mixers (WPA6), Hauf mixers, (the last two mixers using the free-fall principle of operation), zig-zag mixers from the company Niro, and mixers from the company Nauta, in which the mix is circulated by a screw, using the Archimedes principle. Tumbling mixers and Hobart mixers are also suitable.

The product mixture initially produced can be annealed or dried in a suitable dryer. Dryers of the invention may be: fluidized-bed dryers from the company Hosokawa Schugi (Schugi Fluid-Bed, Vometec fluidized-bed dryers), fluidized-bed dryers from the company Waldner or from the company Glatt, turbo-fluidized-bed dryers from the company Waldner, spin-flash dryers from the company Anhydro, or else drum dryers.

Preferred operating conditions in the fluidized-bed dryer are: air inlet temperature from 120 to 280° C., product temperature from 20 to 200° C.

The residual moisture level in the compacted flame-retardant composition of the invention is from 0.01 to 10%, preferably from 0.05 to 1%.

The compacted flame-retardant composition of the invention is preferably used in compounded materials which are subsequently used to produce polymer moldings.

The flame-retardant components may be incorporated into thermoplastic polymers by, for example, premixing all of the constituents in the form of powders and/or granules in a mixer, and then using a compounding assembly (e.g. a twin-screw extruder) for homogenization in the polymer melt. The melt is usually drawn off in the form of a strand, cooled, and granulated. The components may also be introduced separately by way of a feed system directly into the compounding assembly.

It is also possible to admix the flame-retardant additives with ready-to-use polymer granules or with ready-to-use polymer powder, and to process the mixture directly on an injection molding machine to give moldings.

Preferred fillers are glass (preferably in bead or in fiber form), oxides and/or hydroxides of the elements of the second or third main group of the Periodic Table of the Elements (preferably aluminum and magnesium), phyllosilicates, and clay minerals, e.g. bentonites, montmorillonites, hectorites, saponites, precipitated/fumed/crystalline/amorphous silicas, chalk.

Preferred additives are synergists, antioxidants, light stabilizers, lubricants, colorants, nucleating agents, or antistatic agents. Examples of additives which can be used are given in EP-A-584 567.

Experimental Section

Determination of Particle Size Distribution Using the Microtrac Granulometer

Particle size in aqueous dispersion is determined with the aid of a Microtrac ASVR/FRA Granulometer from the company Leeds and Northrup. The degree of reflection or scattering of a laser beam is measured as it penetrates the dispersion. For this, 400 ml of ethanol are pumped through the laser measurement cell. The solid specimen (e.g. 70 mg) is metered in automatically, and after 10 min the particle size distribution is determined. The evaluation unit of the equipment calculates the d₅₀ value and the d₉₀ value.

### Roller Compaction

In a roller compactor (from the company Hosokawa-Bepex, L200/50P), a feed screw is used to pass the starting material between the compactor rolls (setting: level 2-3). This takes place sufficiently rapidly to generate the desired linear pressure with a contact length of 50 mm. The roll rotation rate is set to level 2, and the roll gap is 0.1 mm. The crusts produced (length: about 50 mm, thickness: about 2-5 mm, width: about 10-15 mm) are broken in a hammer mill (from the company Alpine, UPZ), using a screen aperture diameter of 5 mm with a rotation rate of from 600 to 1400 rpm.

### Fractionation of Particles

First, the coarse particles are removed from the broken roller-compacted product on an electrical vibratory sieve (from the company Siemens) with a 1 mm sieve installed. From the material which passes the sieve, the undersize particles are removed using a second sieve (400 μm). The material retained on the sieve is the correct-size particles. The coarse particles are returned to breaking and sieving.

### Determination of Tendency Toward Dusting

10 g of the material to be studied are weighed into a wash bottle.

Nitrogen is passed through the material for 20 min, using a gas flow rate of 1 l/min. The amount of powder remaining after this procedure is weighed. The proportion discharged is divided by the initial weight, and related to 100%.

### Preparation, Processing, and Testing of Flame-Retardant Compounded Materials and Polymer Moldings

The flame-retardant components are mixed with the polymer granules and, where appropriate, with additives, and incorporated in a twin-screw extruder (Leistritz LSM 30/34) at temperatures of from 230 to 260° C. (GR PBT) and, respectively, from 260 to 280° C. (GR PA 66). The homogenized polymer strand is drawn off, cooled in the waterbath, and then granulated.

After adequate drying, the molding compositions are processed on an injection molding machine (Aarburg Allrounder) at melt temperatures of from 240 to 270° C. (GR PBT) and, respectively, from 260 to 290° C. (GR PA 66) to give test specimens, and tested and classified for flame retardancy, using the UL 94 test (Underwriters Laboratories).

### EXAMPLE 1

10 kg of the aluminum salt of diethylphosphonic acid (median particle diameter d₅₀=16 μm) are compacted in compliance with the general “roller compaction” specifications using a linear pressure of 4 kN/cm, and processed to give fractionated particles of from 400 to 1000 μm, following the general “fractionation of particles” specification.

### EXAMPLE 2

10 kg of the aluminum salt of diethylphosphonic acid are compacted in compliance with the general “roller compaction” specifications using a linear pressure of 10 kN/cm, and processed to give fractionated particles of from 400 to 1000 μm, following the general “fractionation of particles” specification.

### EXAMPLE 3

10 kg of the aluminum salt of diethylphosphonic acid are compacted in compliance with the general “roller compaction” specifications using a linear pressure of 30 kN/cm, and processed to give fractionated particles of from 400 to 1000 μm, following the general “fractionation of particles” specification.

### EXAMPLE 4

10 kg of the aluminum salt of diethylphosphonic acid are compacted in compliance with the general “roller compaction” specifications using a linear pressure of 38 kN/cm, and processed to give fractionated particles of from 400 to 1000 μm, following the general “fractionation of particles” specification.

### EXAMPLE 5

5.0 kg of Melapur® MP melamine polyphosphate (melamine phosphate) from the company DSM Melapur, NL are mixed in a tumbling mixer with 5.0 kg of the aluminum salt of diethylphosphinic acid for 5 min.

### EXAMPLE 6

10 kg of the organophosphorus flame-retardant component from example 5 are compacted in compliance with the general “roller compaction” specifications using a linear pressure of 20 kN/cm, and processed to give fractionated particles of from 400 to 1000 μm, following the general “fractionation of particles” specification.

### EXAMPLE 7

10 kg of the aluminum salt of diethylphosphonic acid (median particle diameter d₅₀=56 μm) are compacted in compliance with the general “roller compaction” specifications using a linear pressure of 10 kN/cm, and processed to give fractionated particles of from 400 to 1000 μm, following the general “fractionation of particles” specification.

### EXAMPLE 8

10 kg of a mixture of 99% by weight of the aluminum salt of diethylphosphinic acid and 1% by weight of ®Licowax E are prepared in a tumbling mixer, and compacted in compliance with the general “roller compaction” specifications using a linear pressure of 10 kN/cm, and processed to give fractionated particles of from 400 to 1000 μm, following the general “fractionation of particles” specification.

### EXAMPLE 9

10 kg of a mixture of 90% by weight of the aluminum salt of diethylphosphinic acid and 10% by weight of ®Licowax E are prepared in a tumbling mixer, and compacted in compliance with the general “roller compaction” specifications using a linear pressure of 10 kN/cm, and processed to give fractionated particles of from 400 to 1000 μm, following the general “fractionation of particles” specification.

### EXAMPLE 10

10 kg of a mixture of 98% by weight of the aluminum salt of diethylphosphinic acid and 2% by weight of ®PEG T500 are prepared in a tumbling mixer, and compacted in compliance with the general “roller compaction” specifications using a linear pressure of 10 kN/cm, and processed to give fractionated particles of from 400 to 1000 μm, following the general “fractionation of particles” specification.

### EXAMPLE 11

A mixture of 57.5% by weight of nylon-6,6 (®Ultramid A3), 30% by weight of glass fibers (®Vetrotex EC 10 4.5 mm 98A), and 12.5% by weight of compacted flame-retardant composition from example 1 is cast in compliance with the general specification to give test specimens. Visual sampling shows the surface of the test specimens to be free from inhomogeneities.

### EXAMPLE 12

A mixture of 57.5% by weight of nylon-6,6 (®Ultramid A3), 30% by weight of glass fibers (®Vetrotex EC 10 4.5 mm 98A), and 12.5% by weight of compacted flame-retardant composition from example 3 is cast in compliance with the general specification to give test specimens. Visual sampling shows the surface of the test specimens to be free from inhomogeneities.

### EXAMPLE 13

### Comparison

A mixture of 57.5% by weight of nylon-6,6 (®Ultramid A3), 30% by weight of glass fibers (®Vetrotex EC 10 4.5 mm 98A), and 12.5% by weight of compacted flame-retardant composition from example 4 is cast in compliance with the general specification to give test specimens. Visual sampling shows significant inhomogeneities discernible on the surface of the test specimens.

### EXAMPLE 14

A mixture of 57.5% by weight of nylon-6,6 (®Ultramid A3), 30% by weight of glass fibers (®Vetrotex EC 10 4.5 mm 98A), and 12.5% by weight of compacted flame-retardant composition from example 8 is cast in compliance with the general specification to give test specimens. Visual sampling shows the surface of the test specimens to be free from inhomogeneities.

### EXAMPLE 15

A mixture of 57.5% by weight of nylon-6,6 (®Ultramid A3), 30% by weight of glass fibers (®Vetrotex EC 10 4.5 mm 98A), and 12.5% by weight of compacted flame-retardant composition from example 6 is cast in compliance with the general specification to give test specimens. Visual sampling shows the surface of the test specimens to be free from inhomogeneities.

### EXAMPLE 16

A mixture of 50% by weight of polybutylene terephthalate granules, 30% by weight of glass fibers (®Vetrotex EC 10 4.5 mm 98A), and 20% by weight of compacted flame-retardant composition from example 3 is cast in compliance with the general specification to give test specimens. Visual sampling shows the surface of the test specimens to be free from inhomogeneities.

### EXAMPLE 17

The dusting tendency of the organophosphorus flame-retardant component of example 1 is determined.

TABLE 1
Product compositions

| | | | | | Undersize | Desired | | |
|---|---|---|---|---|---|---|---|---|
| | *CFR composition | | | | particles | particles | | Bulk |
| | | Compacting | | Pressure | <400 μm | 400-1000 μm | | density |
| Ex. | **OPF % | auxiliary | % | kN | Kg | kg | Yield % | g/l |
| 1 | 100 | — | — | 4 | 4.6 | 0.4 | 8.2 | 389 |
| 2 | 100 | — | — | 10 | 3.0 | 2.0 | 39.7 | 443 |
| 3 | 100 | — | — | 30 | 2.4 | 2.6 | 52.9 | 668 |
| 4 | 100 | — | — | 38 | 1.7 | 3.3 | 66.0 | 817 |
| 6 | 100 | — | — | 20 | 1.5 | 3.5 | 70.0 | — |
| 7 | 100 | — | — | 10 | 2.9 | 2.1 | 42.0 | — |
| 8 | 99 | Licowax E | 1 | 10 | 2.0 | 3.0 | 60.0 | — |
| 9 | 90 | Licowax E | 10 | 10 | 1.4 | 3.6 | 71.0 | — |
| 10 | 98 | PEG T500 | 2 | 10 | 1.8 | 3.2 | 64.0 | — |

TABLE 2
Compositions of moldings

| | Composition of molding | | | | |
|---|---|---|---|---|---|
| | | Glass | | | |
| Ex. | CFR % | fiber % | Nylon-6,6 % | PBT % | Comments - |
| 11 | 12.5 | 30 | 57.5 | 0 | CFR: from Ex. 1 |
| 12 | 12.5 | 30 | 57.5 | 0 | CFR: from Ex. 3 |
| 13 | 12.5 | 30 | 57.5 | 0 | CFR: from Ex. 4 |
| (comp.) | | | | | |
| 14 | 12.5 | 30 | 57.5 | 0 | CFR: from Ex. 8 |
| 15 | 12.5 | 30 | 57.5 | 0 | CFR: from Ex. 6 |
| 16 | 20 | 30 | 0 | 50 | CFR: from Ex. 3 |

TABLE 3
Tendency toward dusting

| | Tendency toward | Visual assessment | |
|---|---|---|---|
| Ex. | dusting % | of molding | Comments |
| 11 | 6 | Homogeneous | — |
| 12 | 13 | Homogeneous | — |
| 13 (comp.) | 9 | Inhomogeneous | — |
| 14 | 15 | Homogeneous | — |
| 15 | 12 | Homogeneous | — |
| 16 | — | Homogeneous | — |
| 17 (comp.) | 66 | — | OPF from |
| | | | Ex. 1 |

In all three tables:
*CFR: Compacted flame-retardant composition
**OPF: Organophosphorus flame-retardant component

1.-19. (canceled)

20. A process for producing a compacted flame-retardant composition wherein the compacted flame-retardant composition includes an organophosphorus flame-retardant component with or without a compacting auxiliary comprising the step of compacting the organophosphorus flame-retardant component with or without a compacting auxiliary under a pressure of from 1 to 60 kN/cm².

21. The process for producing compacted flame-retardant composition as claimed in claim 20, which comprises wherein the compacting step further comprises roller compaction.

22. The process as claimed in claim 21, wherein a linear pressure of from 1 to 30 kN/cm is used during the roller compaction.

23. The process as claimed in claim 21, wherein a linear pressure of from 2 to 20 kN/cm is used during the roller compaction.

24. The process as claimed claim 20, wherein the compacting auxiliary is alkylalkoxylates having from 8 to 22 carbon atoms and from 1 to 80 EO units per mole of alcohol.

25. The process as claimed in claim 20, wherein the compacting auxiliary is caprolactam and/or triphenyl phosphate or a mixture thereof.

26. The process as claimed in claim 20, wherein the compacting auxiliary is selected from the group consisting of ethylene glycol, propylene glycol, butylene glycol, their oligomers, polymers, their ethers or a mixture thereof.

27. The process as claimed in claim 20, wherein the compacting auxiliary is selected from the group consisting of naturally occurring, chemically modified, and/or synthetic waxes or a mixture thereof.

28. The process as claimed in claim 20, wherein the compacting auxiliary is a synthetic resin.

29.-40. (canceled)

41. The process as claimed in claim 20, wherein the compacting auxiliary is selected from the group of carnauba waxes and montan waxes.
